(19) United States
(12) Patent Application Publication
(10) Pub. No.: US 2025/0281840 A1
(43) Pub. Date: Sep. 11, 2025

(54) INFORMATION DISPLAY METHOD, STORAGE MEDIUM, AND ELECTRONIC DEVICE

(71) Applicant: NETEASE (HANGZHOU) NETWORK CO., LTD., Hangzhou, Zhejiang (CN)

(72) Inventors: Yuxian WU, Hangzhou, Zhejiang (CN); Xiongbin XIONG, Hangzhou, Zhejiang (CN); Xin GU, Hangzhou, Zhejiang (CN); Peijing YE, Hangzhou, Zhejiang (CN); Haoyi LI, Hangzhou, Zhejiang (CN); Mingyue LIU, Hangzhou, Zhejiang (CN); Zhiling ZHANG, Hangzhou, Zhejiang (CN); Rouyan CHEN, Guangzhou, Guangdong (CN); Jinping ZHANG, Hangzhou, Zhejiang (CN); Yonghao HAN, Hangzhou, Zhejiang (CN)

(73) Assignee: NETEASE (HANGZHOU) NETWORK CO., LTD., Hangzhou, Zhejiang (CN)

(21) Appl. No.: 18/860,019

(22) PCT Filed: Sep. 6, 2022
(86) PCT No.: PCT/CN2022/117353

§ 371 Date: Oct. 25, 2024

(30) Foreign Application Priority Data
Apr. 26, 2022 (CN) 202210449892.8

(51) Int. Cl. A63F 13/63; A63F 13/355; A63F 13/52; A63F 13/814; G06F 3/04883

(52) U.S. Cl. CPC A63F 13/63; A63F 13/355; A63F 13/52; A63F 13/814; G06F 3/04883; A63F 2300/308; A63F 2300/8047

(57) ABSTRACT

A method of displaying information, a storage medium and an electronic device are provided. The method includes: displaying an interactive interface on a first preset area of a display interface of a terminal device, the interactive interface including a preset music score control; obtaining, in response to a touch event on the music score control, music note information of the music score control corresponding to the touch event; and displaying and recording, on a second preset area of the display interface, a music note corresponding to the music note information.

### CROSS-REFERENCE TO RELATED APPLICATIONS

The present application is a U.S. National Stage of International Application No. PCT/CN2022/117353 filed on Sep. 6, 2022, which is based upon and claims priority to Chinese Patent Application No. 202210449892.8, filed on Apr. 26, 2022, and entitled “Method And Device Of Displaying Information, Computer-readable Storage Medium, And Electronic Device”, and the entire contents thereof are incorporated herein by reference for all purposes.

### TECHNICAL FIELD

Embodiments of the present disclosure relate to the field of human-computer interaction technology, and specifically, a method and device of displaying information, a computer-readable storage medium, and an electronic device.

### BACKGROUND

In some related methods for generating music score, music played by a user may be automatically recorded as a music score. However, a recorded note cannot be displayed in real time during the recording process.

### SUMMARY

The present disclosure is to provide a method and device of displaying information, a computer-readable storage medium, and an electronic device.

An aspect of the present disclosure provides a method of displaying information, including:
displaying an interactive interface on a first preset area of a display interface of a terminal device, the interactive interface including a preset music score control;
obtaining, in response to a touch event on the music score control, music note information of the music score control corresponding to the touch event; and
displaying and recording, on a second preset area of the display interface, a music note corresponding to the music note information.

An aspect of the present disclosure provides a computer-readable storage medium having stored thereon a computer program that, when being executed by a processor, implement the method of displaying information described above.

An aspect of the present disclosure provides a n electronic device comprising:
a processor; and
a memory, storing executable instructions of the processor,
wherein the processor is configured to implement the method of displaying information described above.

It should be understood that the above general description and the detailed description that follows are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principles of the present disclosure. Obviously, the accompanying drawings in the following description are only some of the embodiments of the present disclosure, and a person skilled in the art may obtain other accompanying drawings from these drawings without creative labor.

FIG. 1 schematically illustrates a schematic diagram of a music instrument key.

FIG. 2 schematically illustrates a schematic diagram of music score entry.

FIG. 3 schematically illustrates a schematic diagram of another type of key.

FIG. 4 schematically illustrates a schematic diagram of a scene of music score recording according to the key shown in FIG. 3.

FIG. 5 schematically illustrates a flowchart of a method of displaying information according to an example embodiment of the present disclosure.

FIG. 6 schematically illustrates a schematic diagram of an application scene of a cloud game according to an example embodiment of the present disclosure.

FIG. 7 schematically illustrates a schematic scene diagram of a preset music score tool and a music instrument tool according to an example embodiment of the present disclosure.

FIG. 8 schematically illustrates a schematic diagram of an interactive interface having a first preset display manner according to an example embodiment of the present disclosure.

FIG. 9 schematically illustrates a schematic diagram of a scene of music note entry according to an example embodiment of the present disclosure.

FIG. 10 schematically illustrates a schematic diagram of a scene in which music note entry is performed according to an example embodiment of the present disclosure.

FIG. 11 schematically illustrates a schematic diagram of a scene during music note entry according to an example embodiment of the present disclosure.

FIG. 12 schematically illustrates a schematic diagram of a scene of a first touch event input through a plurality of fingers according to an example embodiment of the present disclosure.

FIG. 13 schematically illustrates a schematic diagram of a scene during another music note entry according to an example embodiment of the present disclosure.

FIG. 14 schematically illustrates a schematic diagram of a scene of editing a recorded music note according to an example embodiment of the present disclosure.

FIG. 15 schematically illustrates a schematic diagram of another scene of editing a recorded note according to an example embodiment of the present disclosure.

FIG. 16 schematically illustrates a flowchart of a method of publishing a current music score according to an example embodiment of the present disclosure.

FIG. 17 schematically illustrates a schematic diagram of a scene of configuring a music score detail page for a current music score according to an example embodiment of the present disclosure.

FIG. 18 schematically illustrates a schematic diagram of a scene of playing a music score according to an example embodiment of the present disclosure.

FIG. 19 schematically illustrates a schematic diagram of a scene of a thumbnail state according to an example embodiment of the present disclosure.

FIG. 20 schematically illustrates a schematic diagram of a scene of an expansion state according to an example embodiment of the present disclosure.

FIG. 21 schematically illustrates a block diagram of a device of displaying information according to an example embodiment of the present disclosure.

FIG. 22 schematically illustrates an electronic device for implementing the above-described method of displaying information according to an example embodiment of the present disclosure.

### DETAILED DESCRIPTION

Example embodiments will now be described more fully with reference to the accompanying drawings. However, the example embodiments can be implemented in a variety of forms and should not be construed as being limited to the examples set forth herein; rather, these embodiments are provided so that the present disclosure is more comprehensive and complete, and the idea of the example embodiments can be conveyed in a comprehensive manner to a person skilled in the art. The described features, structures, or characteristics may be combined in one or more embodiments in any suitable manner. In the following description, many specific details are provided so as to give a full understanding of the embodiments of the present disclosure. However, a person skilled in the art will realize that it is possible to practice the technical solution of the present disclosure without one or more of the specific details described, or that other methods, components, devices, steps, and the like may be employed. In other cases, the well-known technical solutions are not shown or described in detail to avoid obscuring aspects of the present disclosure.

In addition, the accompanying drawings are only schematic illustrations of the present disclosure and are not necessarily drawn to scale. The same reference numerals in the drawings indicate the same or similar parts, which thus are not repeated herein. Some of the block diagrams shown in the accompanying drawings are functional entities that do not necessarily have to correspond to physically or logically separate entities. It is possible to implement these functional entities in software form, or in one or more hardware modules or integrated circuits, or in different networks and/or processor devices and/or microcontroller devices.

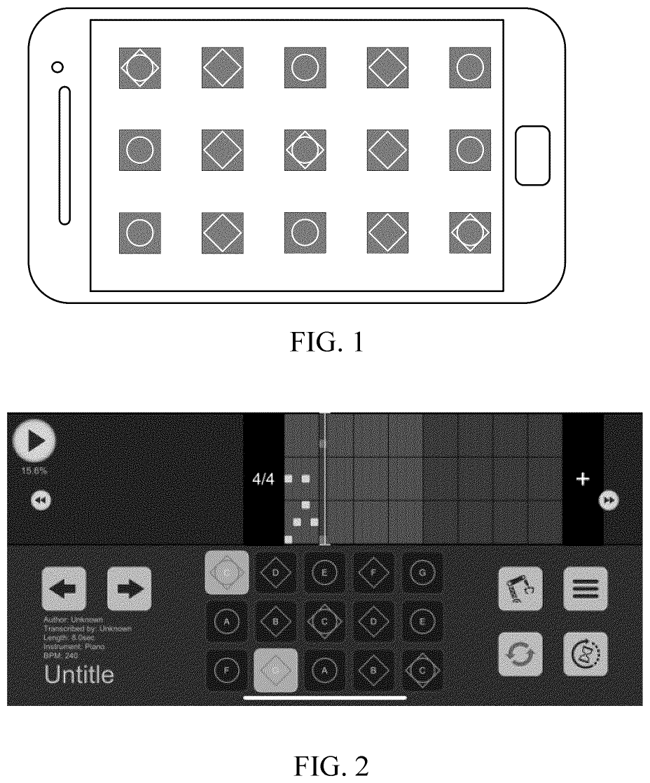

In some game scenes, the recording of a music score may be achieved in the following manner. Specifically, a music instrument tool is built into a game, and a player may use the tool to play music within the game. By taking a certain music game as an example, keys on an interface correspond to music instrument keys, which are do, re, mi, fa, so, la, si (1 group of scales), and are 1, 2, 3, 4, 5, 6, 7 in a staff, and the fifteen keys correspond to 2 groups of scales. Pressing a key may make a corresponding key sound. However, the music instrument tool in the game has fewer built-in music scores, has a different key arrangement from that of a real music instrument, and has no key labelling (as shown in FIG. 1), which increases the learning cost of a novice player.

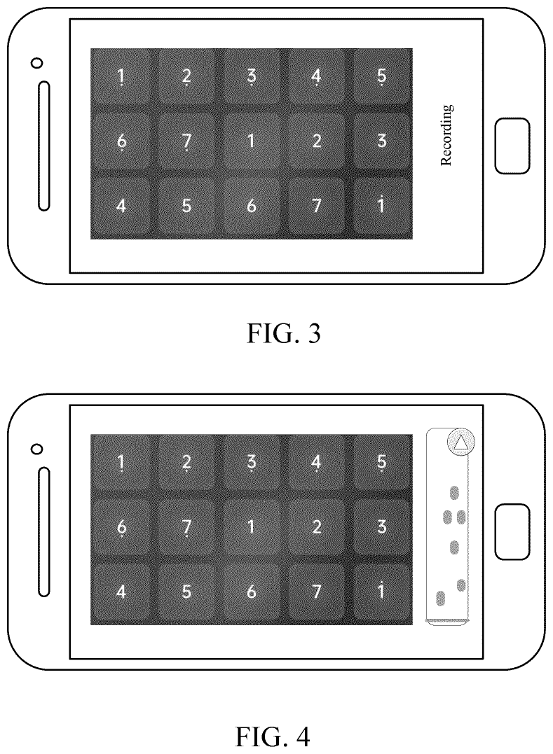

In order to solve the above problem, in some other game scenes, the creation or playing of music score may be achieved in the following ways. Firstly, in a scene of the creation of music score (specifically, it may refer to the scene shown in FIG. 2), the music score may be manually inputted, and one or more syllables may be edited. However, this method requires manual control of a playback bar, and music notes are inputted one by one, which in turn makes the creating process boring, cumbersome, and with a low input efficiency. Secondly, in another scene of the creation of music score (specifically, it may refer to the scenes shown in FIG. 3 and FIG. 4), the music played by a user may be automatically recorded as music score, and individual syllables cannot be edited. However, what has been recorded cannot be viewed in the recording method. After the recording is completed, a staff is not displayed. Moreover, it can only perform re-recording in case of a recording error, and individual syllables cannot be edited, which is of a single function and a low error tolerance rate. Further, in a scene of music score playing, it can be realized in the following way. The user may create and share music score and practice playing in the music score software, and then go back to the game to play the practiced piece. However, the method has the following defects: the user needs to use two devices when practicing, using one device to view the music score, and using the other device to open the game and play. Alternatively, the user may memorize the music score, and then play the music in the game. However, the key arrangement is different from that of a real music instrument, and there is no note labelling, which makes it inconvenient for a novice player or a player with no knowledge of music theory and increases the learning cost.

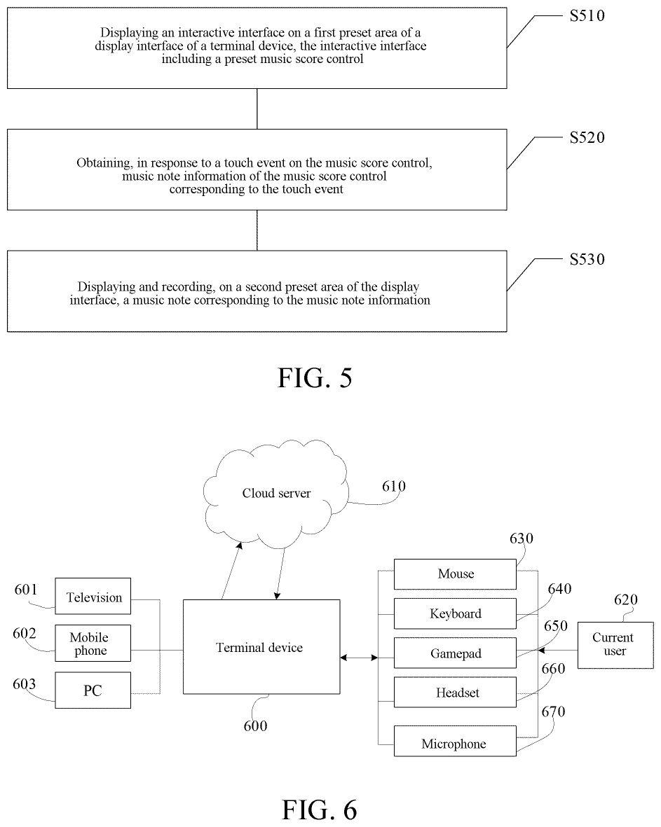

Based on the above, an embodiment of the present disclosure first provides a method of displaying information, which is configured in a terminal device. Of course, a person skilled in the art may conceive of that the method of the present disclosure may be performed on another platform as required, which is not specifically limited in the embodiments. For example, the display terminal may be a television, a computer, a mobile terminal, a PC, or a vehicle-in monitor, or the like. It is to be noted that the specific device form of the display terminal may be selected according to the actual situation, which belongs to the protection scope of the present disclosure. Referring to FIG. 5, the method of displaying information may include:
step S510, displaying an interactive interface on a first preset area of a display interface of a terminal device, the interactive interface including a preset music score control;
step S520, obtaining, in response to a touch event on the music score control, music note information of the music score control corresponding to the touch event; and
step S530, displaying and recording, on a second preset area of the display interface, a music note corresponding to the music note information.

In the above method of displaying information, on the one hand, an interactive interface is displayed on a first preset area of a display interface of a terminal device, then music note information of a music score control corresponding to a touch event is obtained in response to the touch event on the music score control, and finally, a music note corresponding to the music note information is displayed and recorded on a second preset area of the display interface, which achieves a real-time display of the music note and thus solves the problem in the related art in which the recorded music note cannot be displayed in real time; and on the other hand, the music note corresponding to the music note information may be displayed in real time while the music note information is input, which enables a current user to view the input music note in a timely manner, thereby enhancing the convenience of the user in viewing the input music note, and thus improving the user experience.

In the following, the method of displaying information according to an example embodiment of the present disclosure will be explained and illustrated in detail in conjunction with the accompanying drawings.

First, an application scene according to an example embodiment of the present disclosure are explained and illustrated. Specifically, the method of displaying information described in the example embodiment of the present disclosure may be applied to a cloud game scene. That is, it may be applied to the creation of music score or the playing of music score in the cloud game scene, so as to display the created music score or the to-be-played music score, thereby resolving the problem in the related art in which the created music score cannot be displayed in real time or the to-be-played music score cannot be displayed on the same interface while the music score is played. Further, in the method of displaying information described in the example embodiment of the present disclosure, a music score may be automatically recorded, and a staff may be generated and displayed in real time; after the recording of the music score is completed, individual syllables may be arbitrarily modified; on the game interface, a music instrument tool may be opened, and the music score may be created and shared; and on the game interface, a player may be guided to play a specific music score, which may improve the gaming experience of the player.

Next, the cloud game described above is explained and illustrated. Specifically, the cloud game is a game mode based on cloud computing, in which all games are run on a cloud server, and a rendered game screen is compressed and encoded, and then transmitted to the user for operation via the network. With the maturity of the cloud computing and the high-speed transmission capability brought by the gradual development of 5G communication technology, the cloud game has been rapidly developed and gradually popularized. The cloud game adopts “cloud computing+game” mode, in which a user can experience high-end game technology only with a simple equipment without the traditional download, installation, upgrading and other complex operations, and can carry out activities such as gaming or working at any time by invoking the same from the cloud, therefore the remover of hardware is achieved. In the cloud gaming scene, the game does not run in a game terminal of a player but in a cloud server. The cloud server renders the game scene into video and audio streams, transmits the same to the game terminal of the player through the network, and at the same time, the player's operation at the terminal is returned to the cloud server through the network. The game terminal of the player does not need to have powerful graphic computing and data processing capabilities, but only needs to have basic a streaming media playback capability and a capability of obtaining input commands from the player and sending the same to the cloud server.

Specifically, the cloud game scene may be as shown in FIG. 6 below. In FIG. 6, 600 is a terminal device, which may take a TV 601, a mobile phone 602, and a PC (personal computer) 603 as a medium. The terminal device sends a game instruction to a cloud server 610, and in response to the game instruction, the cloud server sends a game screen including audio and video streams, which is obtained by rendering the cloud game and then compressing and encoding the same, to a terminal display for displaying. Then, a current user 620 inputs a corresponding operation instruction via a mouse 630, a keyboard 640, a gamepad 650, a headset 660, and a microphone 670, and of course, the user may also directly input the corresponding operation instruction on a display interface of the display terminal, thereby realizing the operation of the cloud game.

In the method of displaying information provided in an example embodiment of the present disclosure:

in step S510, an interactive interface is displayed on a first preset area of a display interface of a terminal device, and the interactive interface includes a preset music score control.

In an example embodiment, first, the display interface of the display terminal is explained and illustrated. Specifically, the display interface of the display terminal displays a game screen, and the game screen is a video screen obtained by the display terminal playing a video stream received from a cloud server. The video stream is formed by encoding a game screen of a game program running on the cloud server. That is, the game screen in the example embodiments of the present disclosure may be a game screen in the cloud game scene, and may also be a game screen in other game scenes, which is not specifically limited in the example.

Next, the process of generating the display interface is explained and illustrated. Specifically, the game screen described above is a screen displayed in response to an invoking instruction of a preset music instrument tool provided for the game program and corresponding to the music instrument tool. That is, the game screen recited in the example embodiment of the present disclosure is different from an original video screen displayed by the video stream formed in the server. In the game screen recited in the example embodiment of the present disclosure, when a user enters the game through the terminal device, the preset music instrument tool provided by the game program may be invoked, and the preset music instrument tool is displayed on the original video screen. Then, the preset music score tool may be invoked in the cloud game platform, and a mask layer process is performed on the music score tool and the music instrument tool to obtain the display interface having the first preset display manner. In the display interface having the first preset display manner, the preset music score tool floats on a top of the preset music instrument tool. The music score control is a key control of the music score tool, and a music note and/or a staff of the music score control and a music instrument attribute of the music score control are displayed on the music score control. On the interactive interface, a position of the music score control is in one-to-one correspondence with a position of the key control of the preset music instrument tool.

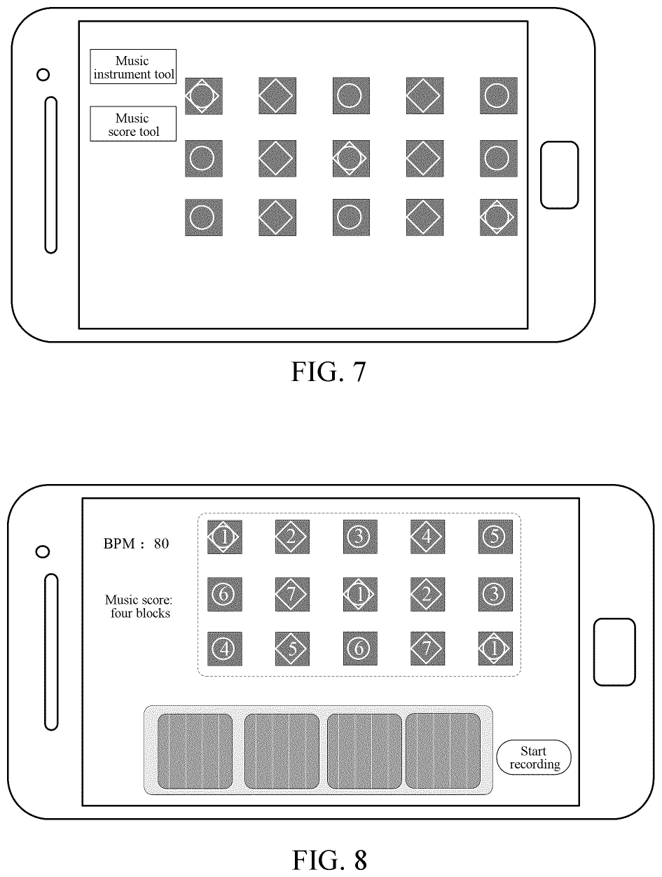

For example, referring to FIG. 7, by taking a XX cloud game as an example, first, a user opens, in the terminal device, the game program corresponding to the cloud game through a client installed in the terminal device, and then touches a music instrument tool control included in the game program so that a preset music instrument tool in the game is invoked. Then, the user touches a music score tool control included in the cloud game platform so that a preset music score tool included in the cloud game platform is invoked. Then, a mask layer process is performed on the music score tool and the music instrument tool to obtain the display interface having the first preset display manner. The display interface obtained may be as specifically shown in FIG. 8. It is to be further noted herein that in the method of displaying information in the example embodiments of the present disclosure, the preset music instrument tool is available in the game program, and the preset music score tool is available in the cloud game platform. When it is necessary to generate the display interface, the preset music instrument tool available in the game program is invoked, then the preset music score tool included in the cloud game platform is invoked, and then the mask layer process is performed on the music instrument tool and the music score tool to obtain a corresponding display interface. The display interface is independent of the cloud game program, and the display interface is displayed only on a particular cloud game platform; and the methods of displaying information in the example embodiments of the present disclosure are all based on the display interface.

In an optional embodiment, a key control layout of the music score tool included in the cloud game platform is pre-fixed based on a key control layout of the music instrument tool. For example, when the preset music instrument tool in the game is invoked, a fixed display interface of the music instrument tool may be displayed on the game screen, which may include a 9-block box or a 15-block box, and when the current user touches the music score tool included in the cloud game platform, a music score tool interface that is pre-set to be consistent with the key control layout of the music instrument tool will be displayed, in which manner the music score tool interface that is consistent with the key control layout of the music instrument tool may be displayed quickly.

In an optional embodiment, the key control layout of the music score tool included in the cloud game platform is dynamically determined by identifying the key control layout of the music instrument tool. For example, when the current user touches the music instrument tool control in the game program, the preset music instrument tool in the game is invoked, a fixed display interface of the music instrument tool may be displayed on the game screen, which may include a 9-block box or a 15-block box, and so on, and when the current user touches the music score tool control included in the cloud game platform, the key control layout of the music instrument tool interface may be identified, and the corresponding music score tool interface is dynamically generated according to the identifying result, in which manner, the music score tool may be adapted to the music instrument tools with different key layout effects.

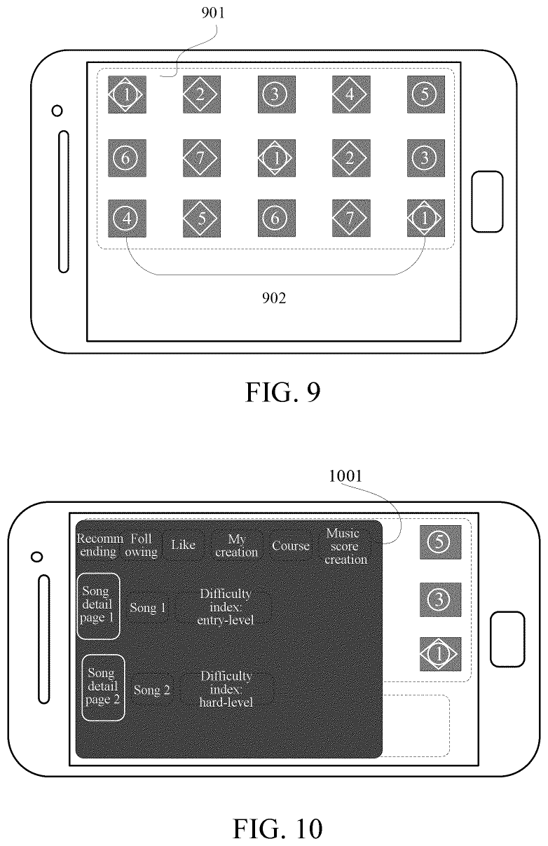

For example, on the interactive interface shown in FIG. 9, the preset music score tool and the preset music instrument tools may be superimposed on each other in the same interface. That is, the music score tool may be overlaid on the music instrument tools by means of a mask layer, and the music score tool of the first layer may be displayed as a semi-transparent layer. Further, on the interactive interface, a music note, a staff corresponding to the key, and various prompt effects of the key may be displayed. Further, since the music score tool is overlaid on the music instrument tool by means of the mask layer, the position of the key control of the music score tool is in one-to-one correspondence with the position of the key control of the music instrument tool on the interactive interface, i.e., the key control of the music score tool is superimposed on the key control of the music instrument tool. In this way, the user may be helped to identify the music note represented by the key control of the music instrument tool in the game, thereby enabling the user to select the corresponding music score control according to actual needs in the process of inputting the music note, which enhances the user experience while improving the efficiency of inputting the music note. Referring to FIG. 9, the first preset area on the display interface may be shown, for example, as 901.

For example, on the interactive interface displayed in the first preset area shown in FIG. 9, the preset music score control may, for example, be as shown as 802, and a music note and/or a staff of the music score control and a music instrument attribute of the music score control are displayed on each music score control. The music note and/or the staff may, for example, be 1234567 of the bass, 1234567 of the alto, and 1234567 of the treble, and so on; and the music instrument attribute may be, for example, a pattern of the music score control, such as a diamond, a circle, or a combination of a diamond and a circle, and so on, which may be also represented in other ways, which is not specifically limited in the example. It is to be further noted here that the 1234567 of the bass, the 1234567 of the alto, and the 1234567 of the treble may be set in corresponding positions according to the actual needs, which is not specifically limited in the example.

Further, after obtaining the above display interface and interactive interface, the interactive interface may be displayed on the first preset area of the display interface of the terminal device. Specifically, it be achieved by: converting, in response to a touch operation of a current user on a scene mode control, the display interface from a current screen scene to a music score creation scene; and displaying the interactive interface comprising the music score tool and the music instrument tool on the first preset area of the display interface of the terminal device, in which a music score creation mode control includes a music score entry control. For example, referring to FIG. 10, the display interface may be converted from a current screen scene to a music score creation scene to enter the creation mode when a touch operation of a current user on a scene mode control illustrated in FIG. 10 (e.g., the music score creation control shown as 1001) is detected. By this method, the music score creation in the cloud game is realized, which solves the problem in the related art that music score creation in the game cannot be realized, and only the music score existing in the game can be played and recorded, thereby further enhancing the user experience.

In step S520, music note information of the music score control corresponding to the touch event is obtained in response to a touch event on the music score control.

For example, referring to FIG. 8, first, a recording mode is entered in response to a touch operation of a current user on a start recording control shown in FIG. 8. Of course, before entering the recording mode, the music score may also be set, for example, by setting a BPM (Byte Per Minute) value and a number of blocks of the music score. The BPM value may be used to control a scrolling speed of the music score on the second display area, and the number of blocks of the music score may be used to control the number of blocks of the music score displayed in the same grid. When the setting is completed and the recording mode is entered, the touch event of the current user on each music score control may be received, and the music note information of the music score control corresponding to each touch event may be obtained.

Further, when the touch event of the current user on any music score control on the interactive interface is detected, the music score control corresponding to the touch event may be displayed in a first display manner on the interactive interface, and another music score control than the music score control corresponding to the touch event may be displayed in a second display manner on the interactive interface, in which the touch event includes at least one of a first touch event inputted through a plurality of fingers, a second touch event inputted through a single finger, or a third touch event inputted through an external device. Further, when the touch event on the music score control has ended, the method of playing information may further includes: adjusting, in response to ending of the touch event, the music score control corresponding to the touch event from the first display manner to the second display manner.

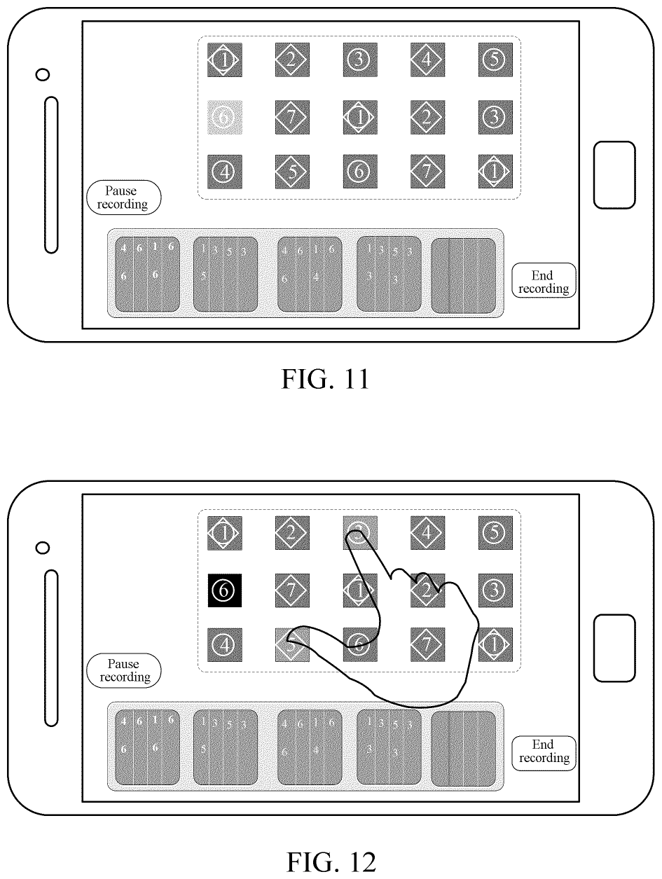

For example, referring to FIG. 11, when the music score control corresponding to the touch event is the bass note 6, the music score control may be displayed in the first display manner, and the other music controls than the base note 6 may be displayed in the second display manner. The brightness of the first display manner is higher than that of the second display manner, or the brightness of the first display manner is lower than that of the second display manner and so on, which is not specifically limited in the example. Adopting different display manner herein is to allow the current user to intuitively view the music note that he or she is currently touching; and at the same time, when the current user no longer touches the interactive control, the display manner of the interactive control may be adjusted from the first display manner to the second display manner, i.e., the original display manner can be restored.

For example, the above touch event may include a first touch event inputted through a plurality of fingers (as shown in FIG. 12), a second touch event inputted through a single finger, and a third touch event inputted through an external device, and the external device may include a mouse, a keyboard, a gamepad and so on, which is not specifically limited in the example.

It is to be further noted herein that when the touch event of the current user on the music score control is detected, in a possible embodiment, a sound pre-configured for the music score control in the game program may be played in response to the touch event of the current user on the music score control, i.e., the music score control does not include a sound, and it may play a sound corresponding to the music score control in the game. In another possible embodiment, a sound possessed by the music score control itself may be played in response to the touch event of the current user on the music score control, i.e., the music score control itself includes a sound, and the sound possessed by the music score control may be played directly.

It is to be noted herein that since the interactive interface formed after the mask layer process is independent of the game program of the cloud game, i.e., the interactive interface formed after the mask layer process is provided by the cloud game platform itself; therefore, in order to enable the current user (i.e., the player) to realize the interaction with the cloud game during the operation of the game, the sound may not be set in the music score control itself. Of course, in a possible embodiment, a switch button may be set regarding whether or not to play the sound possessed by the music score control itself. If the switch button is on, the sound possessed by the music score control itself is played, and if the switch button is off, the sound preconfigured in the game program for the music score control is played, which is not specifically limited in the example.

In step S530, a music note corresponding to the music note information is displayed and recorded on a second preset area of the display interface.

In an example embodiment, displaying, on the second preset area of the display interface, the music note corresponding to the music note information may be achieved by: scrolling and displaying, at a first preset scrolling speed, the music note corresponding to the music note information on the second preset area of the display interface in real time, in which during the scrolling and displaying, a position at which a cursor stays is a position at which a last music note among recorded notes is located.

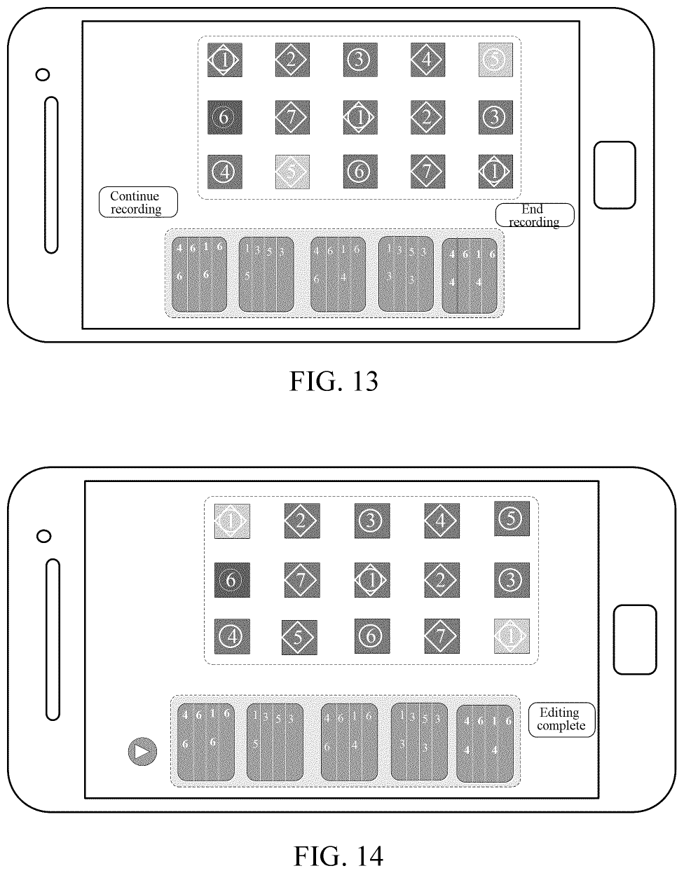

For example, referring to FIG. 13, the music note currently input may be displayed on the second preset area. During displaying the music note currently input, it may be scrolled and displayed at a particular speed (the first preset scrolling speed). The first preset scrolling speed has no relationship with the input speed of the music note by the current user, and may be manually set by the user (manually set the BPM value mentioned above). Further during the scrolling and displaying, the position at which the cursor stays is the currently recorded syllable, i.e., the position at which the last music note among the currently input music notes is located, so that there is no need to manually drag the cursor to the next block after inputting a music note so as to input the next music note. The method may improve the input convenience of the current music note while improving the input efficiency of the currently input music note, thus improving the user experience.

It is to be further noted herein that after displaying the music note corresponding to the music note information, the music note corresponding to the music note information may be recorded and saved, which may facilitate the generation of the current music score based on the music notes corresponding to all the input note information, thereby realizing the creation of the music score by the user.

Further, when the touch event is the first touch event inputted through the plurality of fingers, the music note currently input is displayed in a manner of: sequentially displaying the music notes of the preset music score controls corresponding to the first touch event according to a sequence of an arrangement position of the preset music score control corresponding to the first touch event on the interactive interface. For example, with continued reference to FIG. 13, when the user has entered 4, 5 in the bass region and 2, 3 in the treble region at the same time, 4 in the bass region is displayed first, followed by 5 in the bass region, then 2 in the treble region, and lastly 3 in the treble region. It is further to be noted herein that in an example embodiment of the present disclosure, the music score controls corresponding to the respective music notes are set in the order of bass-alto-treble. In each group of scales, it is set in the order of do (1), re (2), mi (3), fa (4), so (5), la (6), si (7), and thus the display order of the above 4, 5 in the bass region and 2, 3 in the treble region is as follows: first displaying 4 in the bass region, followed by displaying 5 in the bass region, then displaying 2 in the treble region, and lastly displaying 3 in the treble region. In the practical application, the corresponding order may also be set according to the actual needs, which is not specifically limited in the example.

Further, in the specific process of recording the music score, the recording may be paused at any time by touching the pause recording control, and the recording may also be continued by touching the continue recording control, which may be continued on the basis of the pause recording.

In an example embodiment, when the music score recording is completed, the recorded music score may also be edited again. Specifically, it may be achieved by: converting, in response to a touch operation of the current user on a scene mode control, the display interface from a music score creation scene to a music score editing scene; and then editing, in response to a selection operation of a recorded music note on the second display area by the current user, the recorded music note corresponding to the selection operation. Editing the recorded music note corresponding to the selection operation includes: deleting or replacing the recorded music note corresponding to the selection operation; and/or inserting another music note at a position of the recorded music note corresponding to the selection operation.

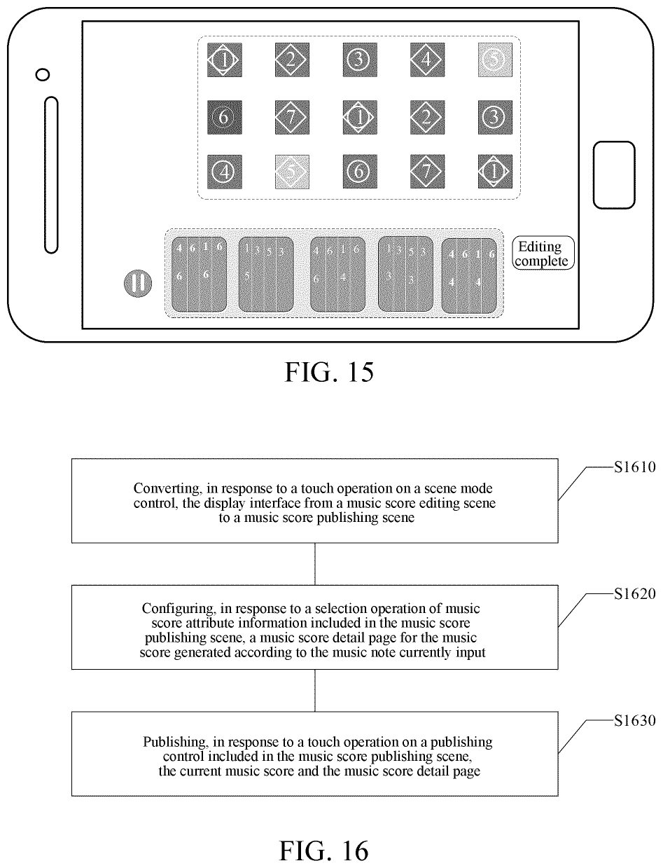

For example, as shown with reference to FIG. 14, when the recording of the music score is completed, an editing mode may be entered. For example, the recorded music score may be played back in the editing mode, and the editing may be performed on one or more of the recorded music notes. Specifically, the editing mode includes deleting the music note, replacing the music note, inserting another music note, and so on. In a specific editing process, on the second display area, a single music note may be selected by a click thereon, the music score control corresponding to the music note may be highlighted on the interactive interface in the first display area, and then the music note may be added or removed by ‘click’ and ‘unclick’ buttons, thereby achieving linking of the first display area and the second display area, and displaying of the modification in real time. At the same time, when there is a situation in which a certain music note is not input, such music note not input may be inputted in the corresponding position, and the positions of the other notes in the blocks may be shifted backward in order, which however may be achieved in other way and is not specifically limited in the example. At the same time, when a playing button is touched, the music score in the second display area may be switched from an editable style to a playing style, and the music score scrolls at an even speed. A specific example diagram of the scene may be referred to that shown in FIG. 15.

FIG. 16 schematically illustrates a flowchart of publishing the current music score. Specifically, publishing the current music score may include:
step S1610, converting, in response to a touch operation on a scene mode control, the display interface from a music score editing scene to a music score publishing scene;
step S1620, configuring, in response to a selection operation of music score attribute information included in the music score publishing scene, a music score detail page for the current music score generated according to the music note currently input; and
step S1630, publishing, in response to a touch operation on a publishing control included in the music score publishing scene, the current music score and the music score detail page.

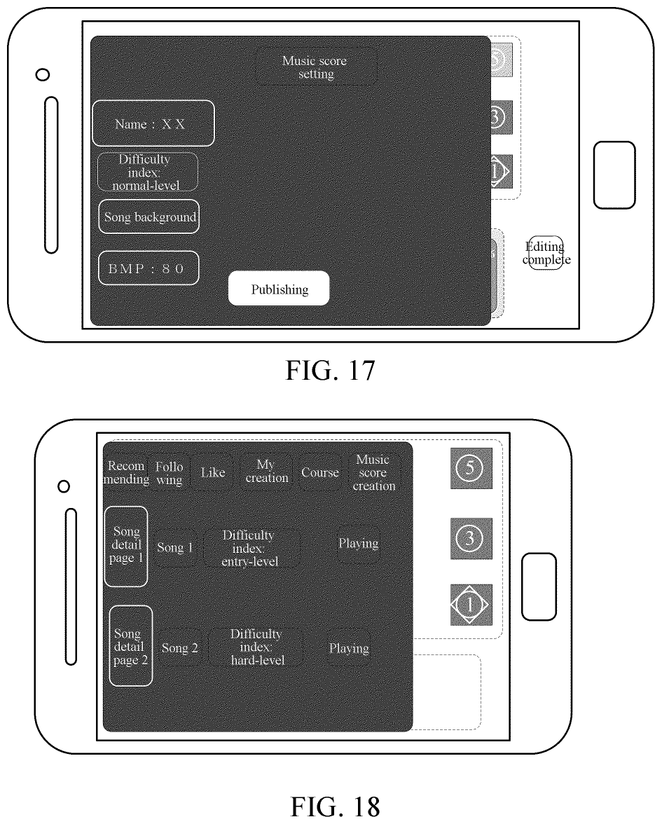

Hereinafter, the method of publishing the current music score of FIG. 16 is explained and illustrated with reference to FIG. 17. Specifically, with reference to FIG. 17, after a music score publishing scene is entered, a song setting control may be touched, and on the song setting interface displayed, attribute information may be configured for the current music score. The attribute information may include a song name, a song difficulty level, a background image, a scrolling speed of the music score, and so on. Other attribute information may also be included such as author, album to which it belongs and so on, which is not specifically limited in the example. Further, after the setting of the attribute information is completed, the publishing control may be touched, thereby achieving publishing the music score detail page and the current music score. If the current music score needs to be edited again, the current music score may also be edited by touching the return control to return back to the editing mode, and then the corresponding control is touched again to publish the music score.

An example embodiment of the present disclosure also recites a method of playing a music score. Specifically, it may be achieved by: first, generating music note feedback information according to a consistency between the music note information of the music score control corresponding to the touch event and a to-be-played music note of a to-be-played music score displayed on the second display area; and then, determining a third display manner of the to-be-played music score according to the music note feedback information and a current music score playing mode, and controlling the to-be-played music score to be displayed in the third display manner on the second display area. The generating the music note feedback information according to the consistency between the music note information of the music score control corresponding to the touch event and the to-be-played music note of the to-be-played music score displayed on the second display area may be achieved by: first, determining whether the music note information of the music score control corresponding to the touch event is consistent with a current to-be-played music note of the to-be-played music score displayed on the second display area; then if the music note information of the music score control corresponding to the touch event is consistent with the current to-be-played music note, generating first music note feedback information; and if the music note information of the music score control corresponding to the touch event is not consistent with the current to-be-played music note, generating second music note feedback information.

In an example embodiment, the current music score playing mode includes a practice playing mode or an automatic playing mode. Determining the third display manner of the to-be-played music score according to the music note feedback information and the current music score playing mode, and controlling the to-be-played music score to be displayed in the third display manner on the second display area includes: when the music score playing mode is the practice playing mode and the music note feedback information is the first music note feedback information, displaying a next to-be-played music note on the second display area; and when the music score playing mode is the automatic playing mode, displaying the to-be-played music score at a second preset scrolling speed on the second display area, and displaying the to-be-played music note of the to-be-played music score and the music score control corresponding to the to-be-played music note in a fourth display manner.

In an example embodiment, the to-be-played music note includes a current to-be-played music note and a next to-be-played music note corresponding to the current to-be-played music note. Displaying the to-be-played music note of the to-be-played music score and the music score control corresponding to the to-be-played music note in the fourth display manner includes: displaying the current to-be-played music note of the to-be-played music score and the music score control corresponding to the current to-be-played music note in a first color identifier; and displaying the next to-be-played music note of the to-be-played music score and the music score control corresponding to the next to-be-played music note in a second color identifier.

For example, as shown in FIG. 18, the touch on the playing control in the music score tool allows entering into the music score playing mode. The music score playing mode may include a practice playing mode and an automatic playing mode. Specifically, in the practice playing mode, when the current user inputs the currently input music note on the interactive interface in the first display area, and the currently input music note is consistent with the current to-be-played music note in the second display area, the next to-be-played music note may be displayed in the second display area (a prompt for a “next syllable” appears). If the currently input music note is not consistent with the current to-be-played music note in the second display area, a corresponding prompt may be provided, which may include but is not limited to: displaying the music score control corresponding to the currently input music note in a certain display manner, and displaying the music score control corresponding to the current to-be-played music note in another display manner, so as to serve as a prompt to the user.

In an example embodiment, when the music score playing mode is the automatic playing mode, the method of displaying information further includes: when the music note feedback information is the first music note feedback information, determining that a current display manner of the music score control corresponding to the touch event is a fifth display manner, and controlling the music score control corresponding to the touch event to be displayed in the fifth display manner; and when the music note feedback information is the second music note feedback information, determining that the current display manner of the music score control corresponding to the touch event is a sixth display manner, and controlling the music score control corresponding to the touch event to be displayed in the sixth display manner.

For example, in the automatic playing mode, a guiding animation may be automatically played in the second display area based on the preset speed of the music score. For example, for the current syllable of the music score (the current to-be-played music note), the corresponding key is displayed in an animation, which becomes from small to big, to guide the user to click (similar to the interaction in the music game), and feedback is provided on the clicking operation of the user, in which the correct playing is shown in a highlighting style, and the incorrect playing is shown in a de-highlighting style. That is, when the music note feedback information is the first music note feedback information, it determines that a current display manner of the music score control corresponding to the touch event is a fifth display manner (highlighting), and the music score control corresponding to the touch event is controlled to be displayed in the fifth display manner (highlighting); and when the music note feedback information is the second music note feedback information, it determines that the current display manner of the music score control corresponding to the touch event is a sixth display manner (de-highlighting), and the music score control corresponding to the touch event is controlled to be displayed in the sixth display manner (de-highlighting).

It is to be further noted that in both the practice and automatic playing modes, “blue” and “green” styles may appear in both the first display area and the second display area appear to distinguish between the “current music note” and the “next music note”. The user clicks on the corresponding music score control in the first display area according to the color prompts to complete the playing.

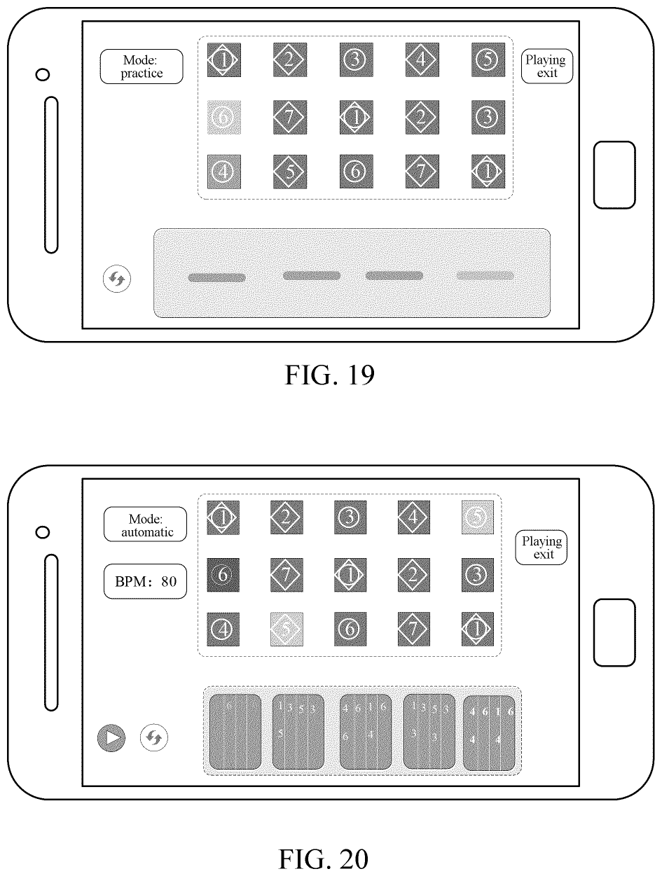

In an example embodiment, the method of displaying information further includes: converting, in response to a touch operation on the to-be-played music score, the to-be-played music score from a first display state to a second display state. The first display state includes a thumbnail state and/or an expansion state. When the first display state is the thumbnail state, the second display state is the expansion state; and when the first display state is the expansion state, the second display state is the thumbnail state. For example, FIG. 19 shows an example diagram of the to-be-played music score in the thumbnail state, and FIG. 20 shows an example diagram of the to-be-played music score in the expansion state. In the actual application process, a corresponding state may be selected according to the actual need. For example, in the playback process of the to-be-played music score or the currently input music score, it does not need to check the music note included in the music score, and thus it may be put in the thumbnail state; and when it needs to play the to-be-played music score or edit the currently input music score, it may be put in the expansion state. That is, it does not need to view the staff during the playback, the music score area may be put in the thumbnail state, and the music score may be viewed by a dragging operation. The music score may be dragged within the area to switch the same to the expansion state; and it may also be switched to the thumbnail state from the expansion state by touching the playback/replay control.

The following is a device embodiment of the present disclosure, which may be used to perform the method embodiment of the present disclosure. For details not disclosed in the device embodiments of the present disclosure, please refer to the method embodiments of the present disclosure.

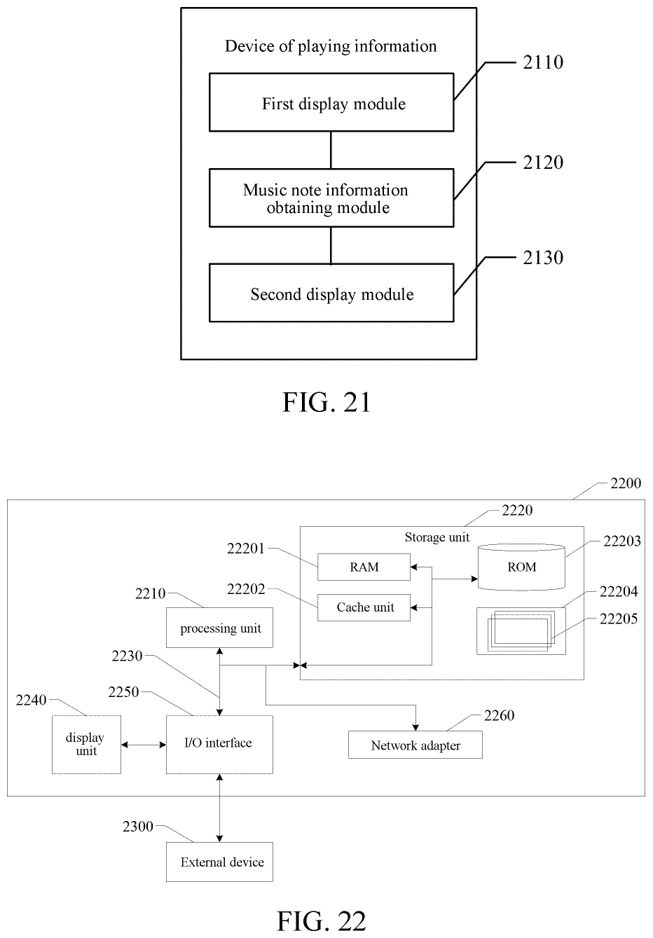

An example embodiment of the present disclosure also provides a device of displaying information configured in a terminal device. Referring to FIG. 21, the device of playing information may include:
a first display module 2110, which may be configured to display an interactive interface on a first preset area of a display interface of a terminal device, the interactive interface including a preset music score control;
a music note information obtaining module 2120, which may be configured to obtain, in response to a touch event on the music score control, music note information of the music score control corresponding to the touch event; and
a second display module 2130, which may be configured to display and record, on a second preset area of the display interface, a music note corresponding to the music note information.

In an embodiment of the present disclosure, the display interface of the terminal device further displays a game screen, the game screen is a video screen obtained by the terminal device playing a video stream received from a cloud server, wherein the video stream is formed by encoding a game screen of a game program running on the cloud server; and the game screen is a screen displayed in response to an invoking instruction of a preset music instrument tool provided by the game program and corresponding to the music instrument tool,
wherein the device of displaying information further includes:
a mask layer module, which may be configured to invoke a preset music score tool included in a cloud game platform, and obtain the display interface having a first display manner by performing a mask layer process on the preset music score tool and the preset music instrument tool,
wherein on the display interface having the first preset display manner, the preset music score tool floats on a top of the preset music instrument tool.

In an embodiment of the present disclosure, the music score control is a key control of the music score tool, and a music note and/or a staff of the music score control and a music instrument attribute of the music score control are displayed on the music score control; and wherein on the interactive interface, a position of the music score control is in one-to-one correspondence with a position of the key control of the preset music instrument tool.

In an embodiment of the present disclosure, displaying the interactive interface on the first preset area of the display interface of the terminal device includes:
converting, in response to a touch operation on a scene mode control, the display interface from a current screen scene to a music score creation scene; and
displaying the interactive interface including the music score tool and the music instrument tool on the first preset area of the display interface of the terminal device.

In an embodiment of the present disclosure, the device of displaying information further includes:
a third display module, which may be configured to display, in a first display manner, the music score control corresponding to the touch event on the interactive interface, and displaying, in a second display manner, another music score control than the music score control corresponding to the touch event on the interactive interface,
wherein the touch event includes at least one of a first touch event inputted through a plurality of fingers, a second touch event inputted through a single finger, or a third touch event inputted through an external device.

In an embodiment of the present disclosure, the device of displaying information further includes:
a display manner adjusting module, which may be configured to adjust, in response to ending of the touch event, the music score control corresponding to the touch event from the first display manner to the second display manner.

In an embodiment of the present disclosure, displaying and recording, on the second preset area of the display interface, the music note corresponding to the music note information includes:
scrolling and displaying, at a first preset scrolling speed, the music note corresponding to the music note information on the second preset area of the display interface in real time, wherein during the scrolling and displaying, a position at which a cursor stays is a position at which a last music note among recorded notes is located.

In an embodiment of the present disclosure, when the touch event is the first touch event inputted through the plurality of fingers, the music note is displayed in a manner of:
sequentially displaying the music notes of the preset music score controls corresponding to the first touch event according to a sequence of an arrangement position of the preset music score control corresponding to the first touch event on the interactive interface.

In an embodiment of the present disclosure, the device of displaying information further includes:
a first scene converting module, which may be configured to convert, in response to a touch operation on a scene mode control, the display interface from a music score creation scene to a music score editing scene; and
a music note editing module, which may be configured to edit, in response to a selection operation of a recorded music note on the second display area, the recorded music note corresponding to the selection operation,
wherein editing the recorded music note corresponding to the selection operation includes:
deleting or replacing the recorded music note corresponding to the selection operation; and/or
inserting another music note at a position of the recorded music note corresponding to the selection operation.

In an embodiment of the present disclosure, the device of displaying information further includes:
a second scene converting module, which may be configured to convert, in response to a touch operation on a scene mode control, the display interface from a music score editing scene to a music score publishing scene;
a music score detail configuring module, which may be configured to configure, in response to a selection operation of music score attribute information included in the music score publishing scene, a music score detail page for a current music score generated according to the music note; and
a music score publishing module, which may be configured to publish, in response to a touch operation on a publishing control included in the music score publishing scene, the current music score and the music score detail page.

In an embodiment of the present disclosure, the device of displaying information further includes:
a music note feedback information generating module, which may be configured to generate music note feedback information according to a consistency between the music note information of the music score control corresponding to the touch event and a to-be-played music note of a to-be-played music score displayed on the second display area; and
a displaying manner determining module, which may be configured to determine a third display manner of the to-be-played music score according to the music note feedback information and a current music score playing mode, and controlling the to-be-played music score to be displayed in the third display manner on the second display area.

In an embodiment of the present disclosure, generating the music note feedback information according to the consistency between the music note information of the music score control corresponding to the touch event and the to-be-played music note of the to-be-played music score displayed on the second display area includes:
determining whether the music note information of the music score control corresponding to the touch event is consistent with a current to-be-played music note of the to-be-played music score displayed on the second display area;
in response to determining that the music note information of the music score control corresponding to the touch event is consistent with the current to-be-played music note, generating first music note feedback information; and
in response to determining that the music note information of the music score control corresponding to the touch event is not consistent with the current to-be-played music note, generating second music note feedback information.

In an embodiment of the present disclosure, the current music score playing mode includes a practice playing mode or an automatic playing mode;
wherein determining the third display manner of the to-be-played music score according to the music note feedback information and the current music score playing mode, and controlling the to-be-played music score to be displayed in the third display manner on the second display area includes:
when the music score playing mode is the practice playing mode and the music note feedback information is the first music note feedback information, displaying a next to-be-played music note on the second display area; and when the music score playing mode is the automatic playing mode, displaying the to-be-played music score at a second preset scrolling speed on the second display area, and displaying the to-be-played music note of the to-be-played music score and the music score control corresponding to the to-be-played music note in a fourth display manner.

In an embodiment of the present disclosure, when the music score playing mode is the automatic playing mode, the device of displaying information further includes:
a fourth display module, which may be configured to, when the music note feedback information is the first music note feedback information, determine that a current display manner of the music score control corresponding to the touch event is a fifth display manner, and control the music score control corresponding to the touch event to be displayed in the fifth display manner; and
a fifth display module, which may be configured to, when the music note feedback information is the second music note feedback information, determine that the current display manner of the music score control corresponding to the touch event is a sixth display manner, and control the music score control corresponding to the touch event to be displayed in the sixth display manner.

In an embodiment of the present disclosure, the to-be-played music note includes a current to-be-played music note and a next to-be-played music note corresponding to the current to-be-played music note;
wherein displaying the to-be-played music note of the to-be-played music score and the music score control corresponding to the to-be-played music note in the fourth display manner includes:
displaying the current to-be-played music note of the to-be-played music score and the music score control corresponding to the current to-be-played music note in a first color identifier; and
displaying the next to-be-played music note of the to-be-played music score and the music score control corresponding to the next to-be-played music note in a second color identifier.

In an embodiment of the present disclosure, the device of displaying information further includes:
a display state converting module, which may be configured to convert, in response to a touch operation on the to-be-played music score, the to-be-played music score from a first display state to a second display state,
wherein the first display state includes a thumbnail state and/or an expansion state, and
wherein when the first display state is the thumbnail state, the second display state is the expansion state; and when the first display state is the expansion state, the second display state is the thumbnail state.

The specific details of each module of the above device of displaying information have already been described in detail in the corresponding method of displaying information, which therefore will not be repeated herein.

It is to be noted that although a number of modules or units of the device for action execution are mentioned in the detailed description above, such division is not mandatory. Indeed, according to an embodiment of the present disclosure, the features and functions of two or more modules or units described above may be specified in a single module or unit. Conversely, the feature and function of one module or unit described above may be further divided to be specified by a plurality of modules or units.

Furthermore, although the various steps of the method in the present disclosure are described in the accompanying drawings in a particular order, it is not required or implied that the steps must be performed in that particular order or that all of the steps shown must be performed in order to achieve a desired result. Additionally or alternatively, certain steps may be omitted, a plurality of steps may be combined to be performed as a single step, and/or a single step may be broken down to be performed as a plurality of steps, and so on.

An embodiment of the present disclosure also provides an electronic device that can implement the above method.

A person skilled in the art may understand that various aspects of the present disclosure may be implemented as a system, method, or program product. Accordingly, various aspects of the present disclosure may be specifically realized in the form of a complete hardware implementation, a complete software implementation (including firmware, microcode, etc.), or a combination implementation of hardware and software, which may be collectively referred to herein as a “circuit”, “module”, or “system”.

An electronic device 2200 according to such an embodiment of the present disclosure is described below with reference to FIG. 22. The electronic device 2200 shown in FIG. 22 is merely an example, and should not impose any limitations on the functionality and use scope of the embodiments of the present disclosure.

As shown in FIG. 22, the electronic device 2200 is represented in the form of a general computing device. The components of the electronic device 2200 may include, but are not limited to: at least one processing unit 2210 as described above, at least one storage unit 2220 as described above, a bus 2230 connecting different system components including the storage unit 2220 and the processing unit 2210, and a display unit 2240.

The memory unit stores program code, the program code may be executed by the processing unit 2210, causing the processing unit 2210 to perform the steps described in the above-described ‘exemplary methods’ in the specification according to various embodiments of the present disclosure. For example, the processing unit 2210 may perform the steps shown in FIG. 5, including:
step S510, displaying an interactive interface on a first preset area of a display interface of a terminal device, the interactive interface including a preset music score control;
step S520, obtaining, in response to a touch event on the music score control, music note information of the music score control corresponding to the touch event; and
step S530, displaying and recording, on a second preset area of the display interface, a music note corresponding to the music note information.

In an embodiment of the present disclosure, the display interface of the terminal device further displays a game screen, the game screen is a video screen obtained by the terminal device playing a video stream received from a cloud server, wherein the video stream is formed by encoding a game screen of a game program running on the cloud server; and the game screen is a screen displayed in response to an invoking instruction of a preset music instrument tool provided for the game program and corresponding to the music instrument tool,
wherein the method of displaying information further includes:
invoking a preset music score tool included in a cloud game platform, and obtaining the display interface having a first display manner by performing a mask layer process on the preset music score tool and the preset music instrument tool,
wherein on the display interface having the first preset display manner, the preset music score tool floats on a top of the preset music instrument tool.

In an embodiment of the present disclosure, the music score control is a key control of the music score tool, and a music note and/or a staff of the music score control and a music instrument attribute of the music score control are displayed on the music score control; and wherein on the interactive interface, a position of the music score control is in one-to-one correspondence with a position of the key control of the preset music instrument tool.

In an embodiment of the present disclosure, displaying the interactive interface on the first preset area of the display interface of the terminal device includes:
converting, in response to a touch operation on a scene mode control, the display interface from a current screen scene to a music score creation scene; and
displaying the interactive interface including the music score tool and the music instrument tool on the first preset area of the display interface of the terminal device.

In an embodiment of the present disclosure, the method of displaying information further includes:
displaying, in a first display manner, the music score control corresponding to the touch event on the interactive interface, and displaying, in a second display manner, another music score control than the music score control corresponding to the touch event on the interactive interface,
wherein the touch event includes at least one of a first touch event inputted through a plurality of fingers, a second touch event inputted through a single finger, or a third touch event inputted through an external device.

In an embodiment of the present disclosure, the method of displaying information further includes:
adjusting, in response to ending of the touch event, the music score control corresponding to the touch event from the first display manner to the second display manner.

In an embodiment of the present disclosure, displaying and recording, on the second preset area of the display interface, the music note corresponding to the music note information includes:
scrolling and displaying, at a first preset scrolling speed, the music note corresponding to the music note information on the second preset area of the display interface in real time, wherein during the scrolling and displaying, a position at which a cursor stays is a position at which a last music note among recorded notes is located.

In an embodiment of the present disclosure, when the touch event is the first touch event inputted through the plurality of fingers, the music note is displayed in a manner of:
sequentially displaying the music notes of the preset music score controls corresponding to the first touch event according to a sequence of an arrangement position of the preset music score control corresponding to the first touch event on the interactive interface.

In an embodiment of the present disclosure, the method of displaying information further includes:
converting, in response to a touch operation on a scene mode control, the display interface from a music score creation scene to a music score editing scene; and
editing, in response to a selection operation of a recorded music note on the second display area, the recorded music note corresponding to the selection operation,
wherein editing the recorded music note corresponding to the selection operation includes:
deleting or replacing the recorded music note corresponding to the selection operation; and/or
inserting another music note at a position of the recorded music note corresponding to the selection operation.

In an embodiment of the present disclosure, the method of displaying information further includes:
converting, in response to a touch operation on a scene mode control, the display interface from a music score editing scene to a music score publishing scene;
configuring, in response to a selection operation of music score attribute information included in the music score publishing scene, a music score detail page for a current music score generated according to the music note; and
publishing, in response to a touch operation on a publishing control included in the music score publishing scene, the current music score and the music score detail page.

In an embodiment of the present disclosure, after obtaining, in response to the touch event on the music score control, the music note information of the music score control corresponding to the touch event, the method of displaying information further includes:
generating music note feedback information according to a consistency between the music note information of the music score control corresponding to the touch event and a to-be-played music note of a to-be-played music score displayed on the second display area; and
determining a third display manner of the to-be-played music score according to the music note feedback information and a current music score playing mode, and controlling the to-be-played music score to be displayed in the third display manner on the second display area.

In an embodiment of the present disclosure, generating the music note feedback information according to the consistency between the music note information of the music score control corresponding to the touch event and the to-be-played music note of the to-be-played music score displayed on the second display area includes:
determining whether the music note information of the music score control corresponding to the touch event is consistent with a current to-be-played music note of the to-be-played music score displayed on the second display area;
in response to determining that the music note information of the music score control corresponding to the touch event is consistent with the current to-be-played music note, generating first music note feedback information; and
in response to determining that the music note information of the music score control corresponding to the touch event is not consistent with the current to-be-played music note, generating second music note feedback information.

In an embodiment of the present disclosure, the current music score playing mode includes a practice playing mode or an automatic playing mode;
wherein determining the third display manner of the to-be-played music score according to the music note feedback information and the current music score playing mode, and controlling the to-be-played music score to be displayed in the third display manner on the second display area includes:
when the music score playing mode is the practice playing mode and the music note feedback information is the first music note feedback information, displaying a next to-be-played music note on the second display area; and
when the music score playing mode is the automatic playing mode, displaying the to-be-played music score at a second preset scrolling speed on the second display area, and displaying the to-be-played music note of the to-be-played music score and the music score control corresponding to the to-be-played music note in a fourth display manner.

In an embodiment of the present disclosure, when the music score playing mode is the automatic playing mode, the method of displaying information further includes:
when the music note feedback information is the first music note feedback information, determining that a current display manner of the music score control corresponding to the touch event is a fifth display manner, and controlling the music score control corresponding to the touch event to be displayed in the fifth display manner; and
when the music note feedback information is the second music note feedback information, determining that the current display manner of the music score control corresponding to the touch event is a sixth display manner, and controlling the music score control corresponding to the touch event to be displayed in the sixth display manner.

In an embodiment of the present disclosure, the to-be-played music note includes a current to-be-played music note and a next to-be-played music note corresponding to the current to-be-played music note;
wherein displaying the to-be-played music note of the to-be-played music score and the music score control corresponding to the to-be-played music note in the fourth display manner includes:
displaying the current to-be-played music note of the to-be-played music score and the music score control corresponding to the current to-be-played music note in a first color identifier; and
displaying the next to-be-played music note of the to-be-played music score and the music score control corresponding to the next to-be-played music note in a second color identifier.

In an embodiment of the present disclosure, the method of displaying information further includes:
converting, in response to a touch operation on the to-be-played music score, the to-be-played music score from a first display state to a second display state,
wherein the first display state includes a thumbnail state and/or an expansion state, and
wherein when the first display state is the thumbnail state, the second display state is the expansion state; and when the first display state is the expansion state, the second display state is the thumbnail state.

The specific contents of the method of displaying information in the present embodiment are also applicable to the embodiment contents of the foregoing method of displaying information, which are not repeated herein.

In the above embodiments, on the one hand, an interactive interface is displayed on a first preset area of a display interface of a terminal device, then music note information of a music score control corresponding to a touch event is obtained in response to the touch event on the music score control, and finally, a music note corresponding to the music note information is displayed and recorded on a second preset area of the display interface, which achieves a real-time display of the music note and thus solves the problem in the related art in which the recorded music note cannot be displayed in real time. On the other hand, the music note corresponding to the music note information may be displayed in real time while the music note information is input, which enables a current user to view the input music note in a timely manner, thereby enhancing the convenience of the user in viewing the input music note, and thus improving the user experience.

The storage unit 2220 may include a readable medium in the form of a volatile storage unit, such as a random access memory unit (RAM) 22201 and/or a cache unit 22202, and may further include a read-only storage unit (ROM) 22203.

The storage unit 2220 may also include a program/utility tool 22204 having a set (at least one) of program modules 22205, and such program module 22205 may include, but not limited to: an operating system, one or more applications, other program modules, and program data, and each of these examples or some combination thereof may include an implementation of a network environment.

The bus 2230 may represent one or more of several types of bus structures, including a memory unit bus or memory unit controller, a peripheral bus, a graphics acceleration port, a processing unit, or a local area bus using any of a variety of bus structures.

The electronic device 2200 may also be in communication with one or more external devices 2300 (e.g., a keyboard, a pointing device, a Bluetooth device, etc.), and may also be in communication with one or more devices that enable a user to interact with the electronic device 2200, and/or may be in communication with any device (e.g., a router, a modem, etc.) that enables the electronic device 2200 to communicate with one or more other computing devices. Such communication may be carried out via the input/output (I/O) interface 2250. And, the electronic device 2200 may also communicate with one or more networks (e.g., a local area network (LAN), a wide area network (WAN), and/or a public network, such as the Internet) via the network adapter 2260. As shown, the network adapter 2260 communicates with other modules of the electronic device 2200 via the bus 2230. It is to be noted that although not shown in the figures, other hardware and/or software modules may be used in conjunction with the electronic device 2200, including, but not limited to: microcode, device drives, redundant processing units, external disk drive arrays, RAID systems, tape drives, and data backup storage systems.

By the foregoing description of embodiments, a person skilled in the art may easily conceive of that the example embodiment described herein may be implemented by software, or may be implemented by software in combination with the necessary hardware. Thus, a technical solution according to an embodiment of the present disclosure may be embodied in the form of a software product that may be stored in a non-volatile storage medium (which may be a CD-ROM, a USB flash drive, a removable hard drive, etc.) or on a network, and that includes a number of instructions for causing a computing device (which may be a personal computer, a server, a terminal device, or a network device, etc.) to perform the method according to an embodiment of the present disclosure.

In an embodiment of the present disclosure, there is also provided a computer-readable storage medium having stored thereon a program product capable of implementing the method described above in the specification. In some possible embodiments, various aspects of the present disclosure may also be realized in the form of a program product including program codes, when the program product runs on a terminal device, the program codes are used to cause the terminal device to perform the steps described in the above-described ‘exemplary methods’ in the specification according to various embodiments of the present disclosure, including:
step S510, displaying an interactive interface on a first preset area of a display interface of a terminal device, the interactive interface including a preset music score control;
step S520, obtaining, in response to a touch event on the music score control, music note information of the music score control corresponding to the touch event; and
step S530, displaying and recording, on a second preset area of the display interface, a music note corresponding to the music note information.

In an embodiment of the present disclosure, the display interface of the terminal device further displays a game screen, the game screen is a video screen obtained by the terminal device playing a video stream received from a cloud server, wherein the video stream is formed by encoding a game screen of a game program running on the cloud server; and the game screen is a screen displayed in response to an invoking instruction of a preset music instrument tool provided for the game program and corresponding to the music instrument tool,
wherein the method of displaying information further includes:
invoking a preset music score tool included in a cloud game platform, and obtaining the display interface having a first display manner by performing a mask layer process on the preset music score tool and the preset music instrument tool,
wherein on the display interface having the first preset display manner, the preset music score tool floats on a top of the preset music instrument tool.

In an embodiment of the present disclosure, the music score control is a key control of the music score tool, and a music note and/or a staff of the music score control and a music instrument attribute of the music score control are displayed on the music score control; and wherein on the interactive interface, a position of the music score control is in one-to-one correspondence with a position of the key control of the preset music instrument tool.

In an embodiment of the present disclosure, displaying the interactive interface on the first preset area of the display interface of the terminal device includes:
converting, in response to a touch operation on a scene mode control, the display interface from a current screen scene to a music score creation scene; and
displaying the interactive interface including the music score tool and the music instrument tool on the first preset area of the display interface of the terminal device.

In an embodiment of the present disclosure, the method of displaying information further includes:
displaying, in a first display manner, the music score control corresponding to the touch event on the interactive interface, and displaying, in a second display manner, another music score control than the music score control corresponding to the touch event on the interactive interface,
wherein the touch event includes at least one of a first touch event inputted through a plurality of fingers, a second touch event inputted through a single finger, or a third touch event inputted through an external device.

In an embodiment of the present disclosure, the method of displaying information further includes:
adjusting, in response to ending of the touch event, the music score control corresponding to the touch event from the first display manner to the second display manner.

In an embodiment of the present disclosure, displaying and recording, on the second preset area of the display interface, the music note corresponding to the music note information includes:
scrolling and displaying, at a first preset scrolling speed, the music note corresponding to the music note information on the second preset area of the display interface in real time, wherein during the scrolling and displaying, a position at which a cursor stays is a position at which a last music note among recorded notes is located.

In an embodiment of the present disclosure, when the touch event is the first touch event inputted through the plurality of fingers, the music note is displayed in a manner of:
sequentially displaying the music notes of the preset music score controls corresponding to the first touch event according to a sequence of an arrangement position of the preset music score control corresponding to the first touch event on the interactive interface.

In an embodiment of the present disclosure, the method of displaying information further includes:
converting, in response to a touch operation on a scene mode control, the display interface from a music score creation scene to a music score editing scene; and
editing, in response to a selection operation of a recorded music note on the second display area, the recorded music note corresponding to the selection operation,
wherein editing the recorded music note corresponding to the selection operation includes:
deleting or replacing the recorded music note corresponding to the selection operation; and/or
inserting another music note at a position of the recorded music note corresponding to the selection operation.

In an embodiment of the present disclosure, the method of displaying information further includes:
converting, in response to a touch operation on a scene mode control, the display interface from a music score editing scene to a music score publishing scene;
configuring, in response to a selection operation of music score attribute information included in the music score publishing scene, a music score detail page for a current music score generated according to the music note; and
publishing, in response to a touch operation on a publishing control included in the music score publishing scene, the current music score and the music score detail page.

In an embodiment of the present disclosure, after obtaining, in response to the touch event on the music score control, the music note information of the music score control corresponding to the touch event, the method of displaying information further includes:
generating music note feedback information according to a consistency between the music note information of the music score control corresponding to the touch event and a to-be-played music note of a to-be-played music score displayed on the second display area; and
determining a third display manner of the to-be-played music score according to the music note feedback information and a current music score playing mode, and controlling the to-be-played music score to be displayed in the third display manner on the second display area.

In an embodiment of the present disclosure, generating the music note feedback information according to the consistency between the music note information of the music score control corresponding to the touch event and the to-be-played music note of the to-be-played music score displayed on the second display area includes:
determining whether the music note information of the music score control corresponding to the touch event is consistent with a current to-be-played music note of the to-be-played music score displayed on the second display area;
in response to determining that the music note information of the music score control corresponding to the touch event is consistent with the current to-be-played music note, generating first music note feedback information; and
in response to determining that the music note information of the music score control corresponding to the touch event is not consistent with the current to-be-played music note, generating second music note feedback information.

In an embodiment of the present disclosure, the current music score playing mode includes a practice playing mode or an automatic playing mode;
wherein determining the third display manner of the to-be-played music score according to the music note feedback information and the current music score playing mode, and controlling the to-be-played music score to be displayed in the third display manner on the second display area includes:
when the music score playing mode is the practice playing mode and the music note feedback information is the first music note feedback information, displaying a next to-be-played music note on the second display area, and
when the music score playing mode is the automatic playing mode, displaying the to-be-played music score at a second preset scrolling speed on the second display area, and displaying the to-be-played music note of the to-be-played music score and the music score control corresponding to the to-be-played music note in a fourth display manner.

In an embodiment of the present disclosure, when the music score playing mode is the automatic playing mode, the method of displaying information further includes:
when the music note feedback information is the first music note feedback information, determining that a current display manner of the music score control corresponding to the touch event is a fifth display manner, and controlling the music score control corresponding to the touch event to be displayed in the fifth display manner; and
when the music note feedback information is the second music note feedback information, determining that the current display manner of the music score control corresponding to the touch event is a sixth display manner, and controlling the music score control corresponding to the touch event to be displayed in the sixth display manner.

In an embodiment of the present disclosure, the to-be-played music note includes a current to-be-played music note and a next to-be-played music note corresponding to the current to-be-played music note;
wherein displaying the to-be-played music note of the to-be-played music score and the music score control corresponding to the to-be-played music note in the fourth display manner includes:
displaying the current to-be-played music note of the to-be-played music score and the music score control corresponding to the current to-be-played music note in a first color identifier; and
displaying the next to-be-played music note of the to-be-played music score and the music score control corresponding to the next to-be-played music note in a second color identifier.

In an embodiment of the present disclosure, the method of displaying information further includes:
converting, in response to a touch operation on the to-be-played music score, the to-be-played music score from a first display state to a second display state,
wherein the first display state includes a thumbnail state and/or an expansion state, and
wherein when the first display state is the thumbnail state, the second display state is the expansion state; and when the first display state is the expansion state, the second display state is the thumbnail state.

The specific contents of the method of displaying information in the present embodiment are also applicable to the embodiment contents of the foregoing method of displaying information, which are not repeated herein.

In the above embodiments, on the one hand, an interactive interface is displayed on a first preset area of a display interface of a terminal device, then music note information of a music score control corresponding to a touch event is obtained in response to the touch event on the music score control, and finally, a music note corresponding to the music note information is displayed and recorded on a second preset area of the display interface, which achieves a real-time display of the music note and thus solves the problem in the related art in which the recorded music note cannot be displayed in real time. On the other hand, the music note corresponding to the music note information may be displayed in real time while the music note information is input, which enables a current user to view the input music note in a timely manner, thereby enhancing the convenience of the user in viewing the input music note, and thus improving the user experience.

A program product for implementing the above method according to embodiments of the present disclosure may employ a portable compact disc read-only memory (CD-ROM) and include program codes, and may run on a terminal device, such as a personal computer. However, the program product of the present disclosure is not limited thereto, and in the present disclosure, the readable storage medium may be any tangible medium that contains or stores a program that may be used by or in combination with an instruction execution system, apparatus or device.

The program product may employ any combination of one or more readable media. The readable medium may be a readable signal medium or a readable storage medium. The readable storage medium may, for example, be, but is not limited to, a system, device, or apparatus that is electrical, magnetic, optical, electromagnetic, infrared, or semiconductor, or any combination thereof. More specific examples of readable storage media (a non-exhaustive list) include: an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The computer-readable signal medium may include a data signal propagated in a baseband or as part of a carrier carrying readable program codes. Such propagated data signals may take a variety of forms, including, but not limited to, electromagnetic signals, optical signals, or any suitable combination thereof. The readable signal medium may also be any readable medium other than the readable storage medium that may send, propagate, or transmit a program for use by or in conjunction with an instruction-executing system, device, or apparatus.

The program code contained on the readable medium may be transmitted using any suitable medium, including, but not limited to: wireless, wire, optical cable, RF, or the like, or any suitable combination thereof.

The program code for performing the operations of the present disclosure may be written in one or more programming languages or combinations thereof, including object-oriented programming languages—such as Java, C++—and conventional procedural programming languages-such as the ‘C’ language or similar programming languages. The program code may be executed entirely on a user computing device, executed partially on the user device, executed as a stand-alone software package, executed partially on the user computing device and partially on a remote computing device, or executed entirely on a remote computing device or server. In the case of the remote computing device, the remote computing may be connected to the user computing device via any kind of network, including a local area network (LAN) or a wide area network (WAN), or may be connected to an external computing device (e.g., by using the Internet of an Internet service provider).

Further, the above-described accompanying drawings are only schematic illustrations of the processes included in the methods according to the embodiments of the present disclosure without limitation. It is readily understood that the processes shown in the above-described accompanying drawings do not indicate or limit the chronological order of these processes. It is also readily understood that the processes may be performed, for example, synchronously or asynchronously in a plurality of modules.

A person skilled in the art may easily conceive of other embodiments of the present disclosure upon consideration of the specification and practice of the invention. The present disclosure is intended to cover any variations, uses, or adaptations of the present disclosure that follow the general principles of the present disclosure and include the common knowledge or customary technical means in the art not disclosed by the present disclosure. The specification and embodiments are to be regarded as exemplary only, and the true scope and spirit of the present disclosure is indicated by the claims.

1. A method of displaying information, comprising:
displaying an interactive interface on a first preset area of a display interface of a terminal device, the interactive interface comprising a preset music score control;
obtaining, in response to a touch event on the music score control, music note information of the music score control corresponding to the touch event; and
displaying and recording, on a second preset area of the display interface, a music note corresponding to the music note information.

2. The method of displaying information according to claim 1, wherein the display interface of the terminal device further displays a game screen, the game screen is a video screen obtained by the terminal device playing a video stream received from a cloud server, wherein the video stream is formed by encoding a game screen of a game program running on the cloud server; and the game screen is a screen displayed in response to an invoking instruction of a preset music instrument tool provided for the game program and corresponding to the music instrument tool,
wherein the method of displaying information further comprises:
invoking a preset music score tool comprised in a cloud game platform, and obtaining the display interface having a first display manner by performing a mask layer process on the preset music score tool and the preset music instrument tool,
wherein on the display interface having the first preset display manner, the preset music score tool floats on a top of the preset music instrument tool.

3. The method of displaying information according to claim 2, wherein the music score control is a key control of the music score tool, and at least one of a music note or a staff of the music score control and a music instrument attribute of the music score control are displayed on the music score control; and wherein on the interactive interface, a position of the music score control is in one-to-one correspondence with a position of the key control of the preset music instrument tool.

4. The method of displaying information according to claim 2, wherein displaying the interactive interface on the first preset area of the display interface of the terminal device comprises:
converting, in response to a touch operation on a scene mode control, the display interface from a current screen scene to a music score creation scene; and
displaying the interactive interface comprising the music score tool and the music instrument tool on the first preset area of the display interface of the terminal device.

5. The method of displaying information according to claim 1, further comprising:
displaying, in a first display manner, the music score control corresponding to the touch event on the interactive interface, and displaying, in a second display manner, another music score control than the music score control corresponding to the touch event on the interactive interface,
wherein the touch event comprises at least one of a first touch event inputted through a plurality of fingers, a second touch event inputted through a single finger, or a third touch event inputted through an external device.

6. The method of displaying information according to claim 5, further comprising:
adjusting, in response to ending of the touch event, the music score control corresponding to the touch event from the first display manner to the second display manner.

7. The method of displaying information according to claim 6, wherein displaying and recording, on the second preset area of the display interface, the music note corresponding to the music note information comprises:
scrolling and displaying, at a first preset scrolling speed, the music note corresponding to the music note information on the second preset area of the display interface in real time, wherein during the scrolling and displaying, a position at which a cursor stays is a position at which a last music note among recorded notes is located.

8. The method of displaying information according to claim 7, wherein when the touch event is the first touch event inputted through the plurality of fingers, the music note is displayed in a manner of:
sequentially displaying the music notes of the preset music score controls corresponding to the first touch event according to a sequence of an arrangement position of the preset music score control corresponding to the first touch event on the interactive interface.

9. The method of displaying information according to claim 1, further comprising:
converting, in response to a touch operation on a scene mode control, the display interface from a music score creation scene to a music score editing scene; and
editing, in response to a selection operation of a recorded music note on the second display area, the recorded music note corresponding to the selection operation,
wherein editing the recorded music note corresponding to the selection operation comprises at least one of:
deleting the recorded music note corresponding to the selection operation;
replacing the recorded music note corresponding to the selection operation; or
inserting another music note at a position of the recorded music note corresponding to the selection operation.

10. The method of displaying information according to claim 1, further comprising:
converting, in response to a touch operation on a scene mode control, the display interface from a music score editing scene to a music score publishing scene;
configuring, in response to a selection operation of music score attribute information comprised in the music score publishing scene, a music score detail page for a current music score generated according to the music note; and
publishing, in response to a touch operation on a publishing control comprised in the music score publishing scene, the current music score and the music score detail page.

11. The method of displaying information according to claim 1, wherein after obtaining, in response to the touch event on the music score control, the music note information of the music score control corresponding to the touch event, the method of displaying information further comprises:
generating music note feedback information according to a consistency between the music note information of the music score control corresponding to the touch event and a to-be-played music note of a to-be-played music score displayed on the second display area; and
determining a third display manner of the to-be-played music score according to the music note feedback information and a current music score playing mode, and controlling the to-be-played music score to be displayed in the third display manner on the second display area.

12. The method of displaying information according to claim 11, wherein generating the music note feedback information according to the consistency between the music note information of the music score control corresponding to the touch event and the to-be-played music note of the to-be-played music score displayed on the second display area comprises:
determining whether the music note information of the music score control corresponding to the touch event is consistent with a current to-be-played music note of the to-be-played music score displayed on the second display area;
in response to determining that the music note information of the music score control corresponding to the touch event is consistent with the current to-be-played music note, generating first music note feedback information; and
in response to determining that the music note information of the music score control corresponding to the touch event is not consistent with the current to-be-played music note, generating second music note feedback information.

13. The method of displaying information according to claim 12, wherein the current music score playing mode comprises a practice playing mode or an automatic playing mode;
wherein determining the third display manner of the to-be-played music score according to the music note feedback information and the current music score playing mode, and controlling the to-be-played music score to be displayed in the third display manner on the second display area comprises:
in response to determining that the music score playing mode is the practice playing mode and the music note feedback information is the first music note feedback information, displaying a next to-be-played music note on the second display area; and
in response to determining that the music score playing mode is the automatic playing mode, displaying the to-be-played music score at a second preset scrolling speed on the second display area, and displaying the to-be-played music note of the to-be-played music score and the music score control corresponding to the to-be-played music note in a fourth display manner.

14. The method of displaying information according to claim 12, wherein when the music score playing mode is the automatic playing mode, the method of displaying information further comprises:
in response to determining that the music note feedback information is the first music note feedback information, determining that a current display manner of the music score control corresponding to the touch event is a fifth display manner, and controlling the music score control corresponding to the touch event to be displayed in the fifth display manner; and
in response to determining that the music note feedback information is the second music note feedback information, determining that the current display manner of the music score control corresponding to the touch event is a sixth display manner, and controlling the music score control corresponding to the touch event to be displayed in the sixth display manner.

15. The method of displaying information according to claim 13, wherein the to-be-played music note comprises a current to-be-played music note and a next to-be-played music note corresponding to the current to-be-played music note;
wherein displaying the to-be-played music note of the to-be-played music score and the music score control corresponding to the to-be-played music note in the fourth display manner comprises:
displaying the current to-be-played music note of the to-be-played music score and the music score control corresponding to the current to-be-played music note in a first color; and
displaying the next to-be-played music note of the to-be-played music score and the music score control corresponding to the next to-be-played music note in a second color.

16. The method of displaying information according to claim 11, further comprising:
converting, in response to a touch operation on the to-be-played music score, the to-be-played music score from a first display state to a second display state,
wherein the first display state comprises a thumbnail state or an expansion state, and
wherein when the first display state is the thumbnail state, the second display state is the expansion state; and when the first display state is the expansion state, the second display state is the thumbnail state.

17. (canceled)

18. A nonvolatile computer-readable storage medium having stored thereon a computer program that, when being executed by a processor, implements actions comprising:
displaying an interactive interface on a first preset area of a display interface of a terminal device, the interactive interface comprising a preset music score control;
obtaining, in response to a touch event on the music score control, music note information of the music score control corresponding to the touch event; and
displaying and recording, on a second preset area of the display interface, a music note corresponding to the music note information.

19. An electronic device comprising:
a processor; and
a memory, storing executable instructions of the processor,
wherein the processor is configured to implement, by executing the executable instructions, actions comprising:
displaying an interactive interface on a first preset area of a display interface of a terminal device, the interactive interface comprising a preset music score control;
obtaining, in response to a touch event on the music score control, music note information of the music score control corresponding to the touch event; and
displaying and recording, on a second preset area of the display interface a music note corresponding to the music note information.

20. The electronic device according to claim 19, wherein the display interface of the terminal device further displays a game screen, the game screen is a video screen obtained by the terminal device playing a video stream received from a cloud server, wherein the video stream is formed by encoding a game screen of a game program running on the cloud server; and the game screen is a screen displayed in response to an invoking instruction of a preset music instrument tool provided for the game program and corresponding to the music instrument tool,
wherein the actions further comprise:
invoking a preset music score tool comprised in a cloud game platform, and obtaining the display interface having a first display manner by performing a mask layer process on the preset music score tool and the preset music instrument tool,
wherein on the display interface having the first preset display manner, the preset music score tool floats on a top of the preset music instrument tool.

21. The electronic device according to claim 20, wherein the music score control is a key control of the music score tool, and at least one of a music note or a staff of the music score control and a music instrument attribute of the music score control are displayed on the music score control; and wherein on the interactive interface, a position of the music score control is in one-to-one correspondence with a position of the key control of the preset music instrument tool.
